(19) United States
(12) Patent Application Publication
(10) Pub. No.: US 2013/0045086 A1
(43) Pub. Date: Feb. 21, 2013

(54) Pump-Turbine Plant

(71) Applicant: Manfred Stummer, Heidenheim (DE)

(72) Inventor: Manfred Stummer, Heidenheim (DE)

(21) Appl. No.: 13/580,899

(22) PCT Filed: Apr. 26, 2012
(86) PCT No.: PCT/EP2012/001781

§ 371 Date: Oct. 26, 2012

(30) Foreign Application Priority Data
Jul. 1, 2011 (DE) 10 2011 107 829.4

(51) Int. Cl. F03B 3/10; F03B 11/00

(52) U.S. Cl. 415/148; 415/174.5; 415/174.1

(57) ABSTRACT

The invention relates to a pump turbine system comprising
a turbine with a turbine impeller as well as a turbine spiral housing;
and a pump with a pump impeller as well as a pump spiral housing;
an electrical machine which is in drive communication with the shaft or can be brought into such communication;
a hydraulic short circuit can be produced between turbine and pump.

The invention is characterized by the following features:
the turbine has a higher rated power than the pump;
a labyrinth seal is formed from the impeller and the housing of each of the hydraulic machines through which a leakage flow flows during operation for cooling and/or lubricating the labyrinth seal;
the labyrinth seal comprises a plurality of annular chambers as well as annular gap-shaped channels connecting these in a conducting manner;
impeller and housing of the relevant hydraulic machine are mounted displaceably relative to one another between an operating position and a non-operating position in the direction of a leakage flow.

The invention relates to a pump turbine system comprising a turbine with a turbine impeller as well as a turbine spiral housing and a pump with a pump impeller as well as a pump spiral housing. Pump and turbine are in drive communication with an electrical machine or can be brought into such communication.

Francis or Pelton turbines are considered as turbines. Furthermore, both the pump and the turbine can be designed as single- or multi-stage so that combinations of a single-stage turbine with a multi-stage pump are feasible or multi-stage turbines with a single- or multi-stage pump.

Pump turbine systems of pump storage power plants have two operating modes, namely a turbine mode and a pump mode. In the latter, the pump pumps water from a lower basin into an upper basin and is driven for this purpose by an electrical machine which is in drive communication with the pump. The electrical machine is fed from a public power supply grid, that is supplied with electrical power.

In turbine mode on the other hand, the water flowing from the upper basin through the turbine into the lower basin drives the turbine which transmits a corresponding power to the electrical machine. The electrical machine converts the drive power into electrical power and feeds this into the power supply grid. The electrical machine thus operates on one occasion as a generator and on another occasion as a motor. It is therefore designated as a motor-generator.

In contrast to the aforesaid generic pump turbine systems, reversible pump turbine systems have also become known in which the turbine and pump are formed by a common impeller so that in turbine mode the common impeller is acted upon with water from the upper basin to generate electrical power and in pump mode it is driven by the electrical machine.

Since such pump storage power plants are used to compensate for load peaks in the power supply grid, the pump turbine must be put into a position to deliver turbine power as rapidly as possible in order to support the power supply grid or to rapidly receive pump power in order to be used for primary grid regulation. It is therefore desirable that the pump turbine of a pump storage power plant can be put into pump mode as rapidly as possible and conversely.

In such systems, changes in the volume flow of the water supplied to the turbine frequently occur. The volume flow can have extreme values, upwards or downwards. The turbine has an optimal efficiency which is obtained near the maximum of the volume flow. When the volume flow is small, the efficiency of the turbine is relatively low. This applies particularly for extreme partial loading. Not only the efficiency is inferior under partial load but also the cavitation behaviour is inferior.

When switching from turbine mode to pump mode and conversely, there are two extreme states: on the one hand, only the turbine can run and the pump is entrained. In this case, the turbine is filled with water and the pump is filled with air. Here one hundred percent turbine capacity is provided.

In the other case, only the pump is filled with water and the turbine is filled with air. Here one hundred percent pump capacity is provided.

Between these two extreme states there is an intermediate state.

In all these cases, the sealing of the gap between the impeller and the housing of the relevant hydraulic machine plays an important role.

Die DE 1 807 443 describes a method and a device for operating a pump turbine system which is temporarily driven without working medium, that is, water. Stepped labyrinths are proposed for sealing the leakage flow between the impeller and the suction pipe of the pump and turbine whereas smooth labyrinths are used in each case for sealing between the impeller and the remaining housing. In order to reduce the power loss of the pump turbine system, during exclusive operation of the pump the gap widths of the labyrinth seals of the pump are minimized whilst the gap widths of the turbine are maximized. The impeller of the turbine then revolves in air. In turbine mode, conversely the gap widths of the labyrinth seals of the turbine are minimized, those of the pump are maximized with the pump impeller then also revolving in air. On transition from pump to turbine mode or conversely, the entire turbine shaft with the pump and turbine impeller is shifted in the axial direction for this purpose.

It is the object of the invention to configure a pump turbine system in such a manner that the problems associated with partial load are avoided. Consequently, the efficiency of a machine set comprising at least one turbine and at least one pump should be optimal over a larger operating range compared with known machine sets. Consequently the efficiency should still be acceptable under extreme partial loading. The cavitation behaviour should be improved. At the same time, the problems associated with the switchover should be avoided. Specifically the power loss should be reduced and the cooling of the seals involved should be optimized.

This object is solved by the features of claim 1.

An essential idea of the invention consists in making the rated power of the turbine greater than the rated power of the pump. In addition, it should be possible to produce a hydraulic short-circuit between turbine and pump.

This has the advantage that even with a small volume flow of the supplied water, the turbine can be driven in an optimal range. It certainly delivers low power but with a substantially better efficiency than was the case in known systems.

Also no additional devices or measures are required for the said expansion of the operating range such as, for example, the stabilization of the running by supplying stabilizing air. Equally well such additional measures can be applied.

The difference between the rated powers of turbines and pump is best selected in such a manner that the efficiency of the turbine at a specific partial load and the efficiency of the hydraulic short-circuit are optimal.

The turbine can have a rated power that lies between one and two times the rated power of the pump, for example 1.1 times, 1.2 times, 1.3 times and so forth up to twice.

It is expedient to fit both hydraulic machines, therefore turbine and pump, each with a controllable guide wheel. This allows controlled switching from hydraulic short-circuit mode into turbine mode and conversely.

A shut-off member (so-called ring gate or cylinder paddle) can be located upstream of each of the turbine impeller or the pump impeller or both of these. The shut-off member can be located between impeller and traverse ring or between impeller and guide apparatus. It is best located upstream directly before the impeller.

A shut-off member, a throttle valve being the best, can also be located downstream of the turbine impeller or the pump impeller, and specifically upstream or downstream of the suction pipe, in extreme cases also inside the suction pipe.

A further essential idea of the invention consists in that the stationary component for adjusting the gap width of the annular gap-shaped channels in the axial direction relative to the revolving component is mounted displaceably between an operating position and a non-operating position in the direction of a leakage flow. In other words, the stationary component is displaced parallel to the axis of rotation of the hydraulic machine relative to the revolving component.

When subsequently mention is only made of hydraulic machine, this always means the water turbine or pump turbine according to the invention.

Operating position in the sense of the present invention means the position of the stationary to the revolving component in which a leakage flow for sealing and cooling then flows in the labyrinth seal. This is the case in operation of the hydraulic machine when the working medium impinges on the rotor blades. Non-operating position means that position in which the labyrinth seal does not seal against the escape of working medium. This is the case, for example, when the working medium of the hydraulic machine is emptied or blown out and its impeller therefore revolves in a medium other than the working medium, in particular air.

Gap width in the present case means the (smallest occurring) distance between two boundary surfaces of the labyrinth seal, in particular the annular gap-shaped channels, which are opposite one another in the operating position. In other words, this is the distance between the mutually facing boundary surfaces which can be measured in an axial section through the axis of rotation of the hydraulic machine perpendicular to the axis of rotation in the axial direction (radial gap). In contrast to this, gap length, also viewed in the same axial section, is understood to be the axial extension of the parts of the mutually opposite annular-gap-shaped channels (parallel to the axis of rotation of the hydraulic machine).

The invention is explained in detail with reference to the drawings. The following is shown in detail therein:

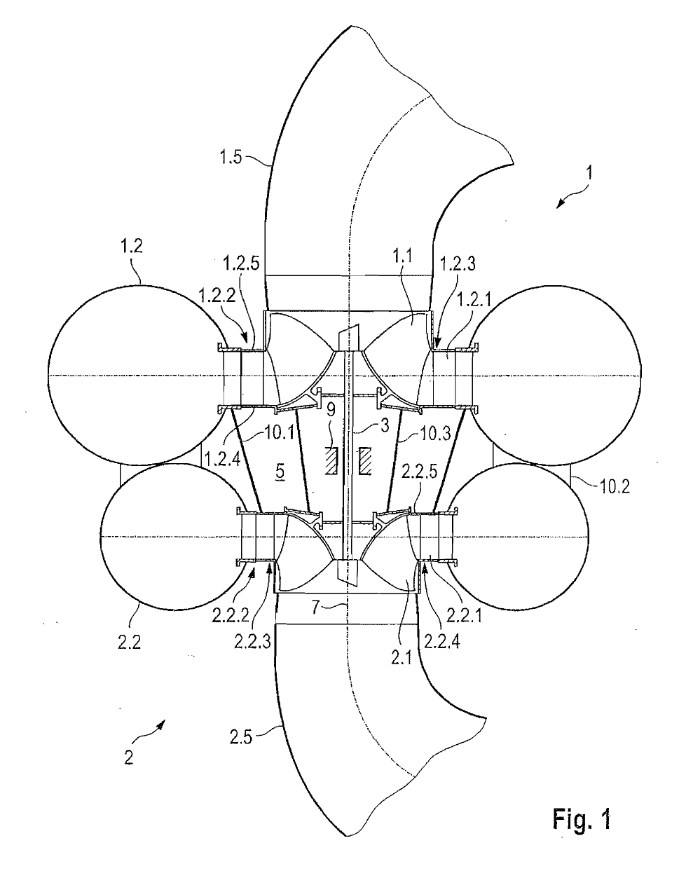

FIG. 1 shows two hydraulic machines executed in Francis design, one as a turbine and one as a pump, in an axial section.

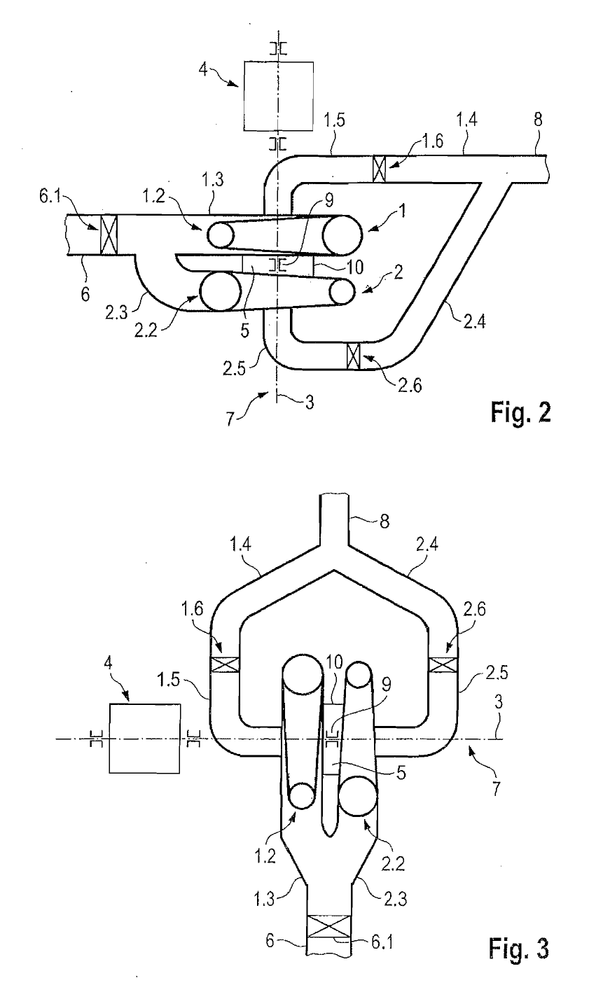

FIG. 2 shows in schematic view a pump turbine system according to a first embodiment with a shaft running in the vertical direction.

FIG. 3 shows in schematic view a further embodiment of the pump turbine system with a shaft disposed in the horizontal direction.

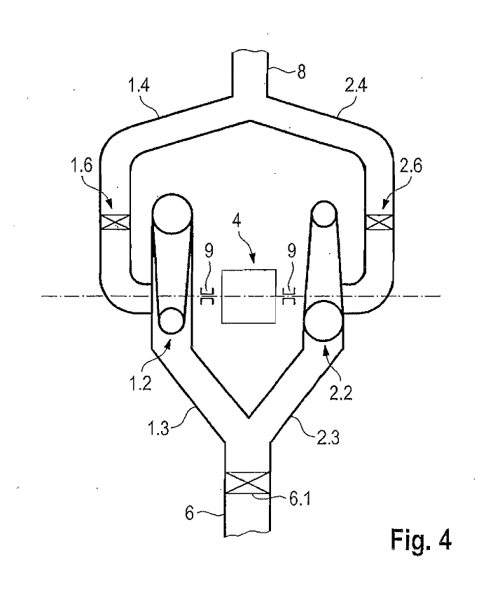

FIG. 4 shows in schematic view a third embodiment in which an electrical machine is located between the two spiral housings.

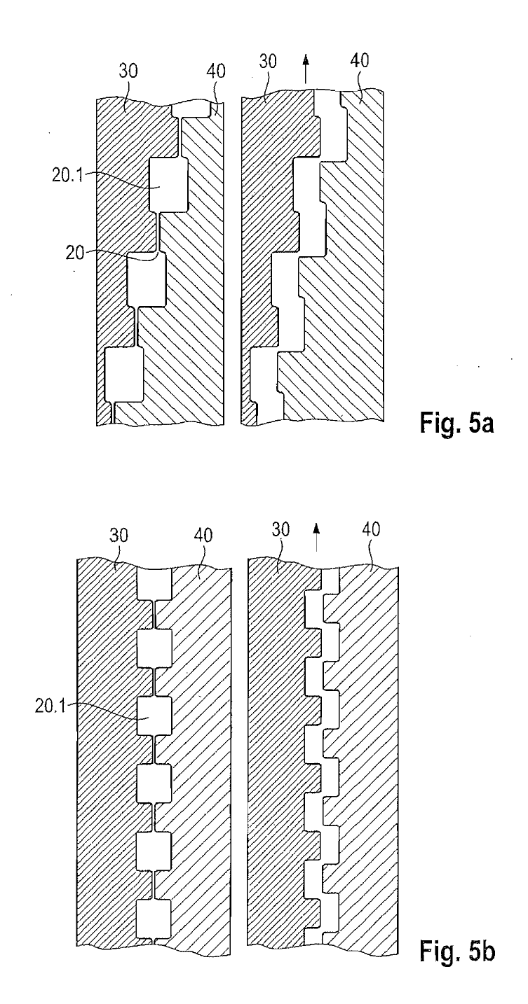

FIGS. 5a and 5b show different embodiments of the labyrinth seal in an operating position and non-operating position of the stationary component.

The pump turbine system shown in FIG. 1 is constructed as follows: the turbine 1 comprises a turbine impeller 1.1 comprising a plurality of rotor blades The turbine impeller 1.1 is connected to a shaft 3 in a torque-proof manner and its axis of rotation 7 is rotatably mounted. The turbine impeller 1.1 is surrounded by a turbine spiral housing 1.2. In addition, a circle of rotor blades is located upstream of the turbine impeller 1.1.

The turbine 1 has a turbine suction pipe 1.5. This is located downstream of the rotor blades and comprises an inlet diffuser with an adjoining manifold and a pipeline which in turn adjoins this, the flow cross-section can expand in the flow direction of the water.

In the present case, a pump 2 is directly facing the turbine 1. The latter means that both hydraulic machines are disposed axially adjacently and no motor-generator is located between them. The pump 2 is here located below the turbine 1. The arrangement can also be reversed with the pump at the top and the turbine at the bottom.

The pump 2 comprises a similar structure to the turbine 1: the pump impeller 2.1 is also executed in a torque-proof manner with the shaft 3 and comprises a plurality of rotor blades. The pump 2 comprises a separate pump spiral housing 2.2 separated hydraulically from the turbine spiral housing 1.2, which surrounds the pump impeller 2.1. A circle of rotor blades 2.2.1 is preferably also located upstream of the pump impeller.

The pump 2 also has a pump suction pipe 2.5 which can be designed in the way as that of the turbine 1.

The turbine 1 is designed in such a manner that its rated power N_{T} is greater than the rated power N_{P} of the pump 2. In the present case, the difference is 2.5. That is, the rated power of the turbine is 2.5 times that of the pump. Larger differences are also feasible, for example, 3 or 4. Almost any value between 1 and . . . 4 or 5 comes into consideration.

Constructively, the differences in the rated powers are brought about by the dimensioning of the pump and the turbine, and specifically in relation to the dimensions and the selected strength values. The figures merely show the relationships schematically without expressing the rated power differences.

In the present case, the two spiral housings 1.2 and 2.2 lie directly above one another at a mutual distance. In the present case, the intermediate space 5 formed by them is free from an electrical machine. In the present case, the intermediate space 5 is delimited by mutually facing spiral housings 1.2 and 2.2. Both spiral housings 1.2 and 2.2 can be supported with respect to one another by means of a supporting element.

The supporting element can be of different shape. In the present case, it is designed as cone envelope 10.1. The cone envelope is supported on the one hand against the traverse ring 1.2.2 of the turbine and on the other hand against the traverse ring 2.2.2 of the pump. A further support 10.2, also in ring form, is located between the spiral housings 1.2 and 2.2. Supports would also be feasible between the spiral housing of one machine and the traverse ring of the other machine.

A shut-off member 1.2.3 is located upstream of the turbine impeller 1.1 and a shut-off member 2.2,3 is located downstream of the pump impeller 2.1—in each case so-called “ring gate” or “cylinder paddle”. The cylinder paddle is therefore arranged between impeller and guide wheel in both hydraulic machines.

Another support 10.3 in the shape of a cylinder is located between the turbine cover and the pump cover. The support 10.3 has the advantage that it brings about a compensation of forces between the two machines. A support between the traverse ring of one machine and the cover of the other machine also comes into consideration.

As can be seen, the shaft 3 is mounted in a bearing 9. The bearing 9 can be integrated in one of the supports 10.1 or 10.3.

The following components can form a single structural unit: the turbine spiral housing 1.2, the pump spiral housing 2.2, the supporting elements 10.1, 10.2, 10.3, possibly the traverse rings 1.2.2 and 2.2.2 as well as the bearing 9. All three of the said supporting elements 10.1, 10.2, 10.3 can be provided, or only one of the supporting elements or two of the supporting elements.

FIG. 2 shows a first embodiment of the pump turbine system according to the invention. As can be seen, a pressure line 1.3 adjoins the turbine spiral housing 1.2 and a pressure line 2.3 adjoins the pump spiral housing 2.2. Both pressure lines 1.3, 2.3 open in a common pressure line 6 in which a common shut-off member 6.1 is located.

The common shut-off member 6.1 in the pressure line 6 preferably remains always open and is only closed in the event of an emergency closure or for maintenance purposes. This brings with it the advantage that both spiral housings 1.1 and 2.2 are always exposed to the same pressure, i.e. the upper water pressure pending at the upper water and consequently are not subjected to frequent load changes.

Both suction pipes 1.5 and 2.5 are each adjoined by corresponding suction lines 1.4 and 2.4. Respectively one separate shut-off member 1.6 and 2.6 is located in both suction lines 1.4 and 2.4. Both suction lines 1.4 and 2.4 open in a common suction line 8.

In the present case, an electrical machine 4 which is designed as a motor-generator is in drive communication with the shaft 3. The latter is located above the turbine 1 and therefore outside the intermediate space 5 axially adjacent to the turbine 1. As a result, it is possible to insert a bearing 9, which for example serves as a guide bearing or combined angular and guide bearing for supporting the shaft 3, in the intermediate space 5 delimited by the two spiral housings 1.2 and 2.2 and by the supporting element 10. The running smoothness of the shaft 3 is thereby further improved.

FIG. 3 shows another embodiment of the pump turbine system according to the invention based on FIG. 2, the arrangement whereof has merely been turned through 90 degrees to the left so that the axis of rotation 3 runs in the horizontal direction and the electrical machine 4 is located laterally adjacent to the two hydraulic machines 1 and 2. Substantially the same structural elements having the same reference numbers as indicated in FIG. 2 are shown here.

FIG. 4 shows another embodiment in which the electrical machine 4 is located between the two spiral housings L2 and 2.2 and specifically proaxially to these. The arrangement of the two spiral housings 1.2 and 2.2 and of the electrical machine 4 can be a strictly symmetrical one.

Preferably, regardless of the position of the shaft 3, both spiral housings 1.2 and 2.2 can be completely embedded in concrete or also arranged to be free-standing. The intermediate space 5 can be configured to be so large that an inspection opening for maintenance or for mounting and dismounting both hydraulic machines can be achieved without any problems.

The invention can be used, inter alia, with the following designs of systems:
Single-stage turbine with single-stage pump.
Single-stage turbine with multi-stage pump.
Multi-stage turbine with single-stage pump.
Multi-stage turbine with multi-stage pump.

The precise structure of a labyrinth seal according to the invention, formed from a fixed component 30 of a hydraulic machine and a revolving component 40 of the machine can be seen from FIGS. 5a and 5b. Recesses are formed in the two components 30 and 40. The boundary surfaces form annular chambers 20.1 as well as annular gap-shaped channels 20.2 interconnecting these in a conducting manner.

The two diagrams 5a and 5b show a very narrow gap. In the right-hand part of one of the FIGS. 5a and 5b the gap is significantly wider. The change comes about through an axial displacement of the two components 30 and 40.

When switching off the working medium the gap width is larger. The through-flowing air ensures on the one hand that ventilation losses are avoided, on the other hand, the labyrinth seal in this case is cooled exclusively by the air moved in this way.

### REFERENCE LIST

1 Turbine

1.1 Turbine impeller

1.2 Turbine spiral housing

1.2.1 Rotor blade

1.2.2 Traverse ring

1.2.3 Shut-off member

1.2.4 Turbine cover pressure side

1.2.5 Turbine cover suction side

1.3 Pressure line

1.4 Suction line

1.5 Turbine suction pipe

1.6 Shut-off member

2 Pump

2.1 Pump impeller

2.2 Pump spiral housing

2.2.1 Rotor blade

2.2.2 Traverse ring

2.2.3 Shut-off member

2.2.4 Pump cover suction side

2.2.5 Pump cover pressure side

2.3 Pressure line

2.4 Suction line

2.5 Pump suction pipe

2.6 Shut-off member

3 Shaft

4 Electrical machine

6 Pressure line

6.1 Shut-off member

7 Axis of rotation

8 Suction line

9 Bearing

10.1 Supporting element

10.2 Supporting element

10.3 Supporting element

20 Labyrinth seal

20.1 Chambers

20.2 Annular gap-shaped channel

30 Fixed component

40 Revolving component

1-13. (canceled)

14. A pump turbine system comprising:
a turbine with a turbine impeller and a turbine spiral housing;
a pump with a pump impeller and a pump spiral housing;
an electrical machine, which is in drive communication with the shaft or can be brought into such communication;
a hydraulic short-circuit can be established between turbine and pump;
characterized by the following features:
the turbine has a higher rated power than the pump;
respectively one labyrinth seal is formed from the impeller and the housing of each of the hydraulic machines, through which a leakage flow for cooling and/or lubricating the labyrinth seal flows during operation;
the labyrinth seal comprises a plurality of annular chambers and annular gap-shaped channels interconnecting these in a conducting manner;
impeller and housing of the relevant hydraulic machine are mounted displaceably relative to one another between an operating position and a non-operating position in the direction of a leakage flow;
at least one of the two machines—turbine or pump—has a controllable guide apparatus;
the rated power N_{T} of the turbine is up to five times higher than the rated power N_{P} of the pump.

15. The pump turbine system according to claim 14, characterized by the following features:
the two spiral housings are disposed in the opposite direction to one another;
the pressure lines of the two spiral housings open into a common pressure line.

16. The pump turbine system according to claim 14, characterized in that the electrical machine is located in an intermediate space between the two spiral housings.

17. The pump turbine system according to claim 15, characterized in that the electrical machine is located in an intermediate space between the two spiral housings.

18. The pump turbine system according to claim 14, characterized in that the electrical machine is located outside an intermediate space between the two spiral housings.

19. The pump turbine system according to claim 15, characterized in that the two spiral housings are directly supported by means of a support element, in particular a cylindrical supporting ring or supporting cone.

20. The pump turbine system according to claim 16, characterized in that the two spiral housings are directly supported by means of a support element, in particular a cylindrical supporting ring or supporting cone.

21. The pump turbine system according to claim 17, characterized in that the two spiral housings are directly supported by means of a support element, in particular a cylindrical supporting ring or supporting cone.

22. The pump turbine system according to claim 18, characterized in that the two spiral housings are directly supported by means of a support element, in particular a cylindrical supporting ring or supporting cone.

23. The pump turbine system according to claim 15, characterized in that a common shut-off member is located in the pressure line.

24. The pump turbine system according to claim 16, characterized in that a common shut-off member is located in the pressure line.

25. The pump turbine system according to claim 17, characterized in that a common shut-off member is located in the pressure line.

26. The pump turbine system according to claim 18, characterized in that a common shut-off member is located in the pressure line.

27. The pump turbine system according to claim 16, characterized in that the pressure lines of the two spiral housings open into a single common pressure line.

28. The pump turbine system according to claim 14, characterized by the following features:
between stationary components and revolving components, labyrinth seals are formed from both components, through which a leakage flow for cooling and/or lubricating the labyrinth seal flows during operation;
labyrinth seal comprises a plurality of annular chambers and annular gap-shaped channels interconnecting these in a conducting manner;
the stationary component is mounted displaceably between an operating position and a non-operating position in the direction of a leakage flow for adjustment of the gap width of the channel in the axial direction relative to the revolving component.

29. The pump turbine system according to claim 28, characterized in that the axial extension of the chambers in the direction of displacement of the stationary component is greater than the axial extension of the annular gap-shaped channel.

30. The pump turbine system according to claim 14, characterized in that the axial extension of the chambers in the relative direction of displacement is greater than the axial extension of the annular gap-shaped channels.

31. The pump turbine system according to claim 28, characterized in that mutually facing boundary surfaces forming the labyrinth seal lie on a cylinder or cone lateral surface and both components are disposed concentrically to one another.

32. The pump turbine system according to claim 4, characterized in that a shut-off member is located upstream or downstream of the turbine impeller and/or the pump impeller.

33. The pump turbine system according to claim 14, characterized in that a shut-off member is assigned to the turbine suction pipe and/or to the pump suction pipe.
